(19) United States
(12) Patent Application Publication
(10) Pub. No.: US 2024/0201630 A1
(43) Pub. Date: Jun. 20, 2024

(54) ASSEMBLY INTENDED TO EQUIP A TIMEPIECE OR WATCH MECHANISM AND COMPRISING AT LEAST ONE RESILIENT ELEMENT AND AT LEAST ONE FIRST AND ONE SECOND WATCH COMPONENT

(71) Applicant: PATEK PHILIPPE SA GENEVE, Genève (CH)

(72) Inventor: Coline JIGUET, Plan-les-Ouates (CH)

(21) Appl. No.: 18/556,015

(22) PCT Filed: Apr. 14, 2022
(86) PCT No.: PCT/IB2022/053523

§ 371 Date: Oct. 18, 2023

(30) Foreign Application Priority Data
Apr. 21, 2021 (EP) 21169694.3

(51) Int. Cl. G04B 21/06

(52) U.S. Cl. CPC G04B 21/06

(57) ABSTRACT

Disclosed is an assembly to equip a timepiece mechanism and including at least one elastic element and at least first and second timepiece components, the elastic element cooperating with the first and second timepiece components and the elastic element, in the rest position, urging the first and second components to displace one of the timepiece components relative to the other. The elastic element includes a first end cooperating with the first component, the first component and the first end of the elastic element being shaped so, in the service position, the torque exerted by the elastic element on the first component and the second component maintains the first end of the elastic element in abutment on the first component at at least three distinct first bearing points that eliminate at least two degrees of freedom of movement between the first end of the elastic element and the first component.

### CROSS-REFERENCE TO RELATED APPLICATIONS

This application is the US national stage of PCT/IB2022/053523, filed Apr. 14, 2022 and designating the United States, which claims the priority of EP 21169694.3, filed Apr. 21, 2021. The entire contents of each foregoing application are incorporated herein by reference.

### BACKGROUND OF THE INVENTION

### Field of the Invention

The object of the present invention is an assembly intended to equip a timepiece mechanism or a timepiece and comprising at least one elastic element, in particular a leaf spring, and at least a first and a second timepiece components.

### Description of the Related Art

In a timepiece mechanism, there are many watch parts or components that are subject to the action of an elastic element, such as a spring or leaf spring. Examples include a star wheel subjected to the action of a jumper, a hammer or rocker subjected to the action of its return spring, or a click which is by definition a lever subjected to the action of a spring.

In general, the elastic element comprises at least one first end rigidly fixed in a first timepiece component, which may be a fixed part (plate, bridge, frame) of the watch movement or a mobile component (hammer, lever, etc.). The second end of the elastic element can either come to bear (punctually or permanently) against a second timepiece component (fixed or mobile) or can also be rigidly fixed to said second timepiece component. In the case of a click, for example, one end of the leaf spring is fixed to a fixed part of the movement, while the other end bears against the lever. As for the hammer, it is possible to rigidly attach both ends of the spring, one to a fixed part of the movement and the other to the hammer.

To rigidly fix one end of the elastic element to a timepiece component (mobile or fixed), a system combining two pins or tubes and one or more screws is generally used (pin-screw connection). It is also possible to crimp the end of the elastic element into a tenon by sliding the said end into a slot in the said tenon before deforming the latter to ensure rigid attachment (connection by permanent deformation of a third part).

In general, the spring element is made of a hard metal, usually steel. Silicon offers a number of advantages for use as a spring or spring element in a watch movement: high tensile strength, lightness, hardness, manufacturing precision, ability to produce complex shapes, low friction, chamfering possible. However, silicon also has its drawbacks, the main one being its brittle nature. For example, it is very difficult to screw the end of an elastic silicon element rigidly onto a timepiece component. The brittle behaviour of silicon requires the use of an intermediate seal, special surface finishes and/or controlled tightening torques, all of which make assembly or manufacture complex. A pin-screw type connection is therefore difficult to implement.

Other types of rigid connection are of course possible for rigidly fixing the end of an elastic silicon element to a timepiece component: bonding, soldering, material growth or a connection by permanent deformation of a third part, as in the case of the tenon described above. These assembly solutions, although functional, are hyperstatic (hyperstatic state is the situation of an assembly in which operation takes place with more stress than is strictly necessary to maintain it, which means that at least one degree of mobility of a part is suppressed several times). These connections also have the disadvantage of not being removable and often do not allow adjustment of the position of the end of the elastic element on the timepiece component.

### SUMMARY OF THE INVENTION

The purpose of the present invention is therefore to propose a solution for assembling an elastic element on a timepiece component which is suitable for fragile materials such as silicon, which ensures a rigid assembly between the elastic element and the timepiece component in the service position of the assembly in a timepiece mechanism and which allows easy assembly and disassembly of the assembly, preferably without tools or deformation of the parts. Preferably, the assembly solution according to the invention also enables the position and force of the elastic element exerted on the timepiece components to be adjusted.

The object of the present invention is an assembly comprising at least one elastic element and at least one first and one second timepiece components as disclosed and claimed.

### BRIEF DESCRIPTION OF THE DRAWINGS

The attached figures illustrate schematically and by way of example several embodiments of the invention.

FIG. 1 illustrates a first embodiment of the invention comprising a hammer and its return spring.

FIG. 2 illustrates a variant of the design shown in FIG. 1.

FIGS. 3a and 3b illustrate a variant of the first embodiment of the invention, enabling the force of the elastic element to be adjusted.

FIGS. 4a to 4c illustrate a second embodiment of the invention and its variants.

FIG. 5 illustrates a variant of the invention and of the embodiments of FIGS. 1 to 4c.

### DETAILED DESCRIPTION

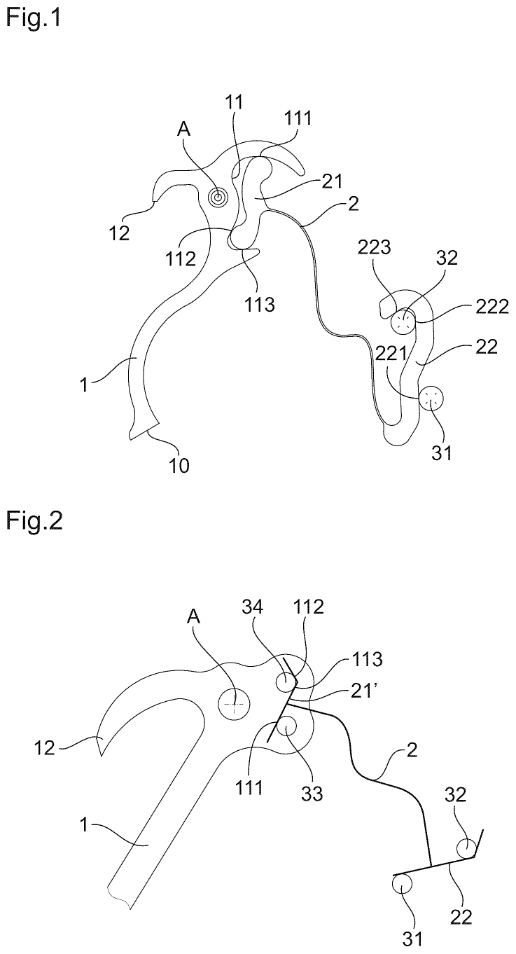

The first embodiment of the invention illustrated in FIG. 1 comprises a chronograph hammer 1 pivoted in A and subjected to the action of its return spring 2. The hammer 1 and return spring 2 assembly is intended to equip a timepiece mechanism and in particular a chronograph mechanism.

Conventionally, the hammer 1 comprises an active end 10 intended to cooperate with a chronograph heart-piece of the chronograph mechanism and a beak 12 intended to cooperate with a control member (column wheel for example). The return spring 2 comprises a first end 21 designed to cooperate with the hammer 1 and a second end 22 designed to be rigidly connected to a fixed part (bridge or plate for example, not illustrated) of the chronograph mechanism.

Usually, this second end 22 of the return spring 2 is rigidly fixed in said fixed part by means of pins and screws. As for the first end 21 of the return spring 2, it either rests against a portion of the hammer 1, or is also rigidly fixed to the hammer 1 by a pin and screw system.

If the return spring 2 is to be made of silicon, it is very difficult to screw one or both of its ends 21, 22 into another component to ensure a rigid connection.

The invention thus proposes another type of rigid connection between the return spring 2, the fixed part of the mechanism and the hammer 1, which guarantees the rigidity necessary for the operation of the assembly in service in a timepiece mechanism, but also the use of brittle material, preferably silicon, oxidised silicon or a ceramic, for the return spring 2.

In the first embodiment, for the hammer 1/return spring 2 assembly to operate, in the service position of the assembly in a chronograph mechanism, the first end 21 of the return spring 2 must be rigidly connected to the hammer 1 so as to be fixed relative to the hammer 1 at least along the x and y axes, i.e., in the plane of the hammer 1. Similarly, in the service position, the second end 22 of the return spring 2 must be rigidly connected to a fixed part of a timepiece mechanism, so as to be fixed relative to this fixed part at least along the x and y axes.

To this end, in the first embodiment illustrated, the first end 21 of the return spring 2 has a first particular shape designed to be housed in a counter-form 11 made in the hammer 1. The second end 22 of the return spring 2 has a second particular shape designed to cooperate with two fixed elements of the fixed part of the chronograph mechanism, represented by first and second stops or pins 31 and 32 in FIG. 1.

In this first embodiment, in the operating position of the assembly in the chronograph mechanism (assembled position of the assembly in the chronograph mechanism and hammer 1 at rest, FIG. 1), the return spring 2 is prestressed, i.e., it exerts a torque on the hammer 1 and the first and second stops 31, 32. This torque is arranged to tend to move the hammer 1 so that it strikes the chronograph heart-piece. According to the invention, the prestressing torque of the return spring 2 tends to maintain the first end 21 of the return spring 2 in the counter-shape 11 of the hammer 1, the contact between these two elements taking place in at least, but preferably exactly, three distinct first point bearing zones 111, 112, 113. In addition, the prestressing torque tends to keep the second end 22 of the return spring 2 bearing against the first and second stops 31, 32 in at least three separate second point bearing zones 221, 222, 223, (i.e., at least one second point bearing zone 221 on the first stop 31 and at least two second point bearing zones 222, 223 on the second stop 32, as illustrated, or vice versa).

Thus, in the operating position of the assembly, the connection between the first end 21 of the return spring 2 and the counter-form 11 of the hammer 1, the connection between the second end 22 of the return spring 2 and the first and second stops 31, 32, and the prestressing torque of the return spring 2 form an assembly or rigid embedding of the return spring 2 in the hammer 1 and on the fixed part of the mechanism (represented by the stops 31, 32) in which all the degrees of freedom incompatible with the operation of the assembly are blocked. In the illustrated embodiment, there is locking along the x and y axes, locking in z not being essential for operation of the hammer 1. For locking in the z direction, particularly in the event of an impact, one solution is to select the return spring 2 so that the preload torque generates sufficient friction to ensure that the spring 2 is held in the z direction. Another solution for maintaining the spring along the z axis is described below with reference to FIG. 5. The assembly is thus isostatic, since it operates without excessive stress, and the fundamental principle of statics is sufficient to determine all the unknown parameters of the linkage in the hammer/spring/fixed part assembly. Certain degrees of mobility are suppressed (in x and y), but each degree of mobility is suppressed only once.

In this first embodiment, in the service position of the assembly in the chronograph mechanism (a position which corresponds to the rest position of the hammer in the chronograph mechanism), the return spring 2 therefore exerts an elastic force on the hammer 1, a force which therefore serves on the one hand to return the hammer the operation of the assembly and also to rigidly connect the return spring 2 to the hammer 1. The return spring 2 in the operating position therefore exerts a stress on the hammer 1 and on the fixed stops 31, 32 designed to move the hammer relative to the said stops to return it to its initial position and to guarantee the rigid connection between the return spring 2 and the hammer 1.

The return spring 2 is preferably made of silicon, oxidised silicon or another brittle material (glass, sapphire, ceramic, etc.). The use of these materials for the return spring 2 is facilitated by the present invention since it is not necessary to screw/drill/pinch/plastically deform the return spring 2 for its assembly on the hammer 1 and/or the fixed part (represented by the stops 31, 32).

In this first embodiment, the arrangement of the parts has the advantage of taking up less space in terms of height, since the return spring 2 and the hammer 1 are in the same plane.

Alternatively, the form-in-form connection between the first end 21 of the return spring 2 and the hammer 1 can be replaced by a connection of the type between the second end 22 of the return spring 2 and first and second stops 31, 32. FIG. 2 illustrates this variant in which the hammer 1 carries third and fourth stops 33, 34 arranged to cooperate with the first end 21′ of the return spring 2. In the operating position of the assembly in the chronograph mechanism, with the hammer 1 at rest, the prestressing torque of the return spring 2 tends to keep the first end 21′ of the return spring 2 bearing against the third and fourth stops 33, 34 in at least three first point bearing zones 111, 112, 113 (for example, at least one first point bearing zone 111 on the third stop 33 and at least two first point bearing zones 112, 113 on the fourth stop 34, as illustrated). This variant returns to the two levels (hammer and return spring) usually found with a hammer/spring assembly assembled by a pin/screw connection. This variant also makes it possible to keep an existing hammer and adapt it for use with a return spring in a fragile material such as silicon or oxidised silicon.

In another variant of this first embodiment, the return spring could comprise an end fixed to its corresponding timepiece component (fixed part or hammer) by any appropriate means known to the person skilled in the art. For example, one end of the return spring could be rigidly fixed to the hammer or to a fixed part by means of a pin/screw connection or by permanent deformation of an additional assembly part. In this case, the other end of the return spring is fixed to the other of the hammer or fixed part according to the rigid connection by obstacles described above.

In another alternative example, the return spring is made in one piece with the hammer or the fixed part, the connection with this component therefore being one-piece, while the other end of the return spring is fixed to the other of the hammer or the fixed part according to the rigid connection by obstacles described above.

Finally, in a variant of FIG. 2, the third and fourth stops 33, 34 could be carried by the first end 21′ of the return spring 2 while the hammer 1 has a portion shaped to cooperate with each of these stops to form a rigid connection by obstacles as described above.

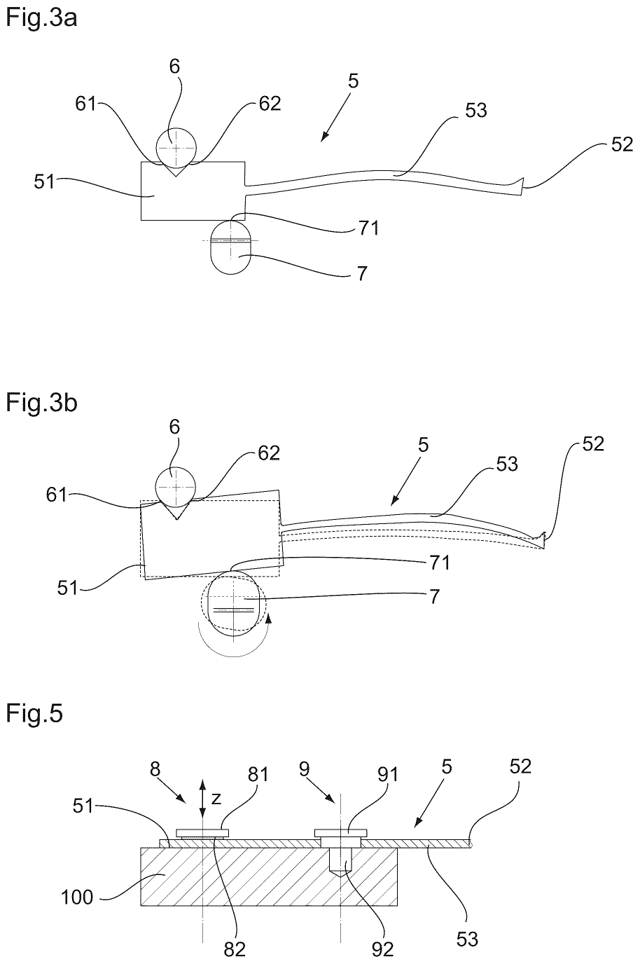

In a second embodiment illustrated in FIGS. 3a and 3b, the assembly according to the invention formed by at least one elastic element intended to cooperate with at least a first and a second timepiece components is arranged to enable the position of the elastic element, its loading and therefore the force exerted on the said timepiece components to be adjusted. This design also makes it easier to fit the elastic element.

In this embodiment, the elastic element 5 comprises a first end 51 intended to be rigidly connected to a fixed part of a timepiece mechanism in the service position and an elastic arm 53 terminated by a second end 52 intended to cooperate with a second timepiece component not illustrated for setting this second timepiece component in motion. In particular, the first end 51 is arranged to cooperate with a first stop 6 and a second stop 7 fixed in the timepiece mechanism. In particular, this first end 51 comprises a shape, in this case a V-shaped slot, in which the first stop 6 is housed.

As in the first embodiment above, in the operating position of the assembly (assembled position of the elastic element between the fixed part and the second component in the timepiece mechanism), the elastic element 5 and in particular its arm 53 is pre-stressed, i.e. it exerts a torque on the second component (not illustrated) via its second end 52 and on the first and second stops 6, 7. On the one hand, this torque tends to move the second component relative to the fixed stops 6, 7 for the operation of the assembly. According to the invention, this torque also tends to maintain the first end 51 of the elastic element in contact with the first and second stops 6, 7 and in particular the first stop 6 in the slot in the first end 51. The contact between the first end 51 and the two stops 6, 7 takes place in at least three, preferably exactly three, point bearing zones: two first point bearing zones 61, 62 between the slot and the first stop 6 and a third point bearing zone 71 between the first end 51 and the second stop 7. In the service position of the assembly, the connection between the first end 51 of the elastic element 5 and the stops 6, 7 is therefore similar to the connection between the second end 22 of the return spring 2 and the first and second stops 31, 32 of the first embodiment: it is a rigid connection by obstacles in which certain degrees of mobility are eliminated (here, in x and y), but each degree of mobility is eliminated only once.

The special feature of this embodiment is that the second stop 7 is an adjustable stop such as, for example, an eccentric as shown in FIGS. 3a and 3b. By pivoting the eccentric 7, it is possible to adjust the position of the first end 51 and therefore the cocking of the elastic element 5 and its elastic arm 53 and the force exerted by said arm and the second end 52 of the elastic element 5 on the second timepiece component (not shown) to set it in motion. This arrangement also makes it easier to fit the elastic element 5, in particular by the presence of clearance between the first end 51 of the elastic element 5 and the eccentric 7.

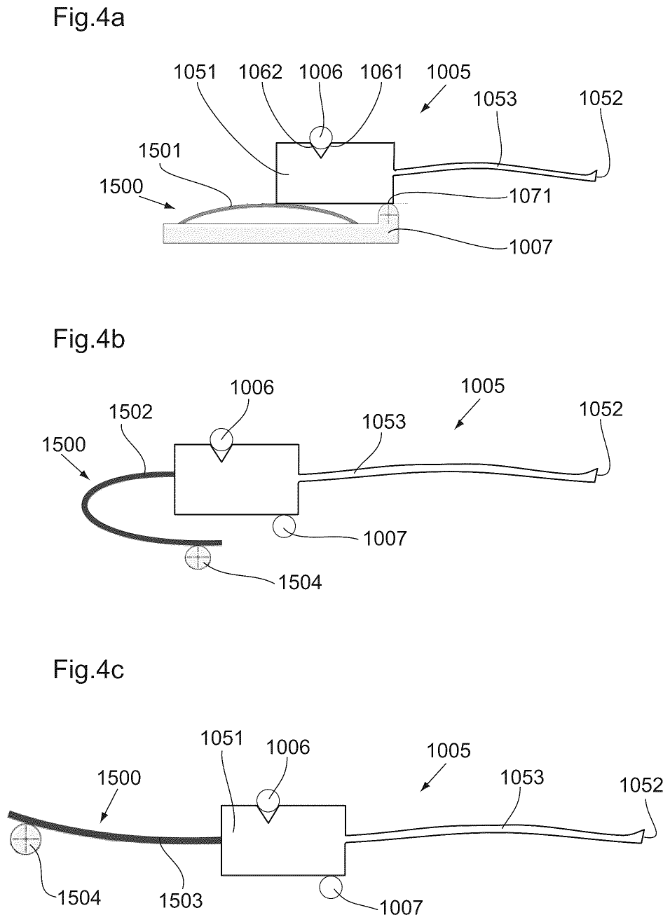

A third embodiment of the invention illustrated in FIGS. 4a to 4c applies to the case where, in the service position of the assembly in a timepiece mechanism, the elastic element does not exert (sufficient) pre-stress on the timepiece component to which it is to be rigidly connected.

In this third embodiment, the elastic element 1005 comprises a first end 1051 intended to be rigidly connected to a first timepiece component (symbolised by the stops 1006, 1007) in the service position of the assembly and an elastic arm 1053 terminating in a second end 1052 intended to cooperate with a second timepiece component (not illustrated) for its displacement during operation of the assembly. In particular, the first end 1051 is arranged to cooperate with a first stop 1006 and a second stop 1007, both integral with the first timepiece component. In particular, this first end 1051 comprises a shape, in this case a V-shaped slot, in which the first stop 1006 is housed.

In this third embodiment, in the operating position of the assembly, the elastic element 1005 is not (not at all or not sufficiently) preloaded and does not exert sufficient torque on the stops 1006 and 1007 to keep the first end 1051 of the elastic element 1005 in contact with the first and second stops 1006, 1007 and in particular the first stop 1006 in the slot in the first end 1051. This is the case, for example, if the contact between the second end of the elastic element and the second timepiece component is not permanent but only punctual during operation of the assembly. In other words, the elastic element 1005 in the operating position does not exert sufficient torque on the first component and the stops 1006 and 1007 to form a rigid connection by obstacles similar to the connection between the second end 22 of the return spring 2 and the first and second stops 31, 32 of the first embodiment.

Consequently, in this third embodiment, the elastic force required to create the rigid obstacle connection between the elastic element 1005 and the first component (1006, 1007) is exerted by additional elastic means. Elastic means 1500 are therefore provided, arranged to exert a force or torque on the elastic element 1005 and its first end 1051. This torque tends to keep the first end 1051 of the elastic element 1005 in contact with the first and second stops 1006, 1007 and in particular the first stop 1006 in the slot in the first end 1051. The contact between the first end 1051 and the two stops 1006, 1007 takes place in at least three, preferably exactly three, point bearing zones: two first point bearing zones 1061, 1062 between the slot and the first stop 1006 and a third point bearing zone 1071 between the first end 1051 and the second stop 1007. Thus, thanks to the elastic means 1500, in the service position of the assembly, the connection between the first end 1051 of the elastic element and the stops 1006, 1007 is similar to the connection between the second end 22 of the return spring 2 and the first and second stops 31, 32 of the first form of execution: it is a rigid connection by obstacles in which certain degrees of mobility are eliminated (here, in x and y), but each degree of mobility is eliminated only once.

FIGS. 4a to 4c illustrate three variants of the additional elastic means 1500.

In FIG. 4a, the additional elastic means 1500 comprise a leaf spring 1501 arranged between the first component and the first end 1051 of the elastic element 1005. In this variant, the leaf spring 1501 bears against the first end 1051 of the elastic element 1005 but is not fixed to it. The leaf spring 1501 is chosen and arranged to exert, in the operating position of the assembly, a force or torque on the first end 1051 which tends to keep the said first end 1051 of the elastic element 5 in contact with the first and second stops 1006, 1007 and in particular the first stop 1006 in the slot in the first end 1051. The leaf spring 1501 thus helps to form a rigid connection by obstacles similar to that described above for the first and second embodiments.

FIGS. 4b and 4c illustrate a variant of the additional elastic means 1500 in which these additional elastic means 1500 comprise a leaf spring 1502, 1503, at least one end of which is fixed to the elastic element 1005 (either the leaf spring 1502, 1503 is attached to the elastic element 1005 or the leaf spring 1502, 1503 is made in one piece with the elastic element 1005). The other end of the leaf spring 1502, 1503 comes to bear against a third stop 1504 carried by a fixed part of the movement or by the first component. As in the previous variant, the leaf spring 1502, 1503 is chosen and arranged between the third stop 1504 and the elastic element 1005 in order to exert, in the operating position of the assembly, a force or a torque on the first end 1051 which tends to keep the said first end 1051 of the elastic element 1005 in contact with the first and second stops 1006, 1007 and in particular the first stop 1006 in the slot in the first end 1051. The leaf spring 1502, 1503 thus helps to form a rigid connection by obstacles similar to that described above for the first embodiment. The variants in FIGS. 4b and 4c differ in the shape of the leaf spring (straight for leaf spring 1503 and curved for leaf spring 1502).

In the variant shown in FIG. 4a, the ends of the leaf spring 1501 bear against or are fixed to a bearing point integral with the stop 1007. Generally speaking, this variant illustrates the case where the elastic means 1500 are arranged between the first component and the elastic element of the assembly according to the invention. Alternatively, the elastic means 1500 could bear on a fixed part of the movement distinct from the first component of the assembly according to the invention.

In a variant of this third embodiment, the second stop 1007 and/or the bearing point 1504 of the elastic means 1500 could be adjustable stops as in the second form of execution described in FIGS. 3a and 3b.

In the above embodiments, the connections between the first end of the elastic element and the timepiece component or components (hammer or fixed part) are arranged to eliminate the degrees of mobility of the elastic element in x and y. The elastic element remains free along the z axis, a degree of mobility that does not always need to be limited to ensure that the elastic element functions correctly. As mentioned previously, one solution for limiting the degree of mobility in z is to choose the elastic element and/or the elastic means so that the torque generated exerts sufficient friction on the component to limit movements along the z axis. Another solution is illustrated in FIG. 5, in which the elastic element is also restrained in the z direction.

In this variant, the elastic element 5 still comprises a first end 51 intended to be rigidly connected to a first timepiece component 100 in the service position of the assembly and an elastic arm 53 terminated by a second end 52 intended to cooperate with a second timepiece component not illustrated for setting it in motion. In particular, the first end 51 is arranged to cooperate with a first stop 8 and a second stop 9 fixed in the first timepiece component 100, which may be a fixed part of a timepiece mechanism. In particular, this first end 51 comprises a shape (not visible in FIG. 5) in which the first stop 8 is housed.

As in the first embodiment above, in the operating position of the assembly (assembled position of the elastic element between the fixed part and the second component in the timepiece mechanism), the elastic element 5 and in particular the elastic arm 53 is prestressed, i.e. the said elastic arm 53 exerts a torque on the second component (not illustrated) via its second end 52 and on the first and second stops 8, 9. This torque tends, on the one hand, to move the second component relative to the fixed part for the operation of the assembly and, on the other hand, this torque tends to maintain the first end 51 of the elastic element in contact with the first and second stops 8, 9 and in particular the first stop 8 in the slot in the first end 51. The contact between the first end 51 and the two stops 8, 9 takes place in at least three, preferably exactly three, point bearing zones: two first point bearing zones between the slot and the first stop 8 and a third point bearing zone between the first end 51 and the second stop 9. Alternatively, in the event that the elastic element 5 is not sufficiently pre-stressed in the service position, elastic means such as those described with reference to the third embodiment could be provided to ensure that the first end 51 of the elastic element 5 is held in contact with the first and second stops 8, 9 and the connection by obstacles between the elastic element 5 and the first component 100 in the service position.

In this variant, the first and second stops 8, 9 comprise a head 81, 91 covering a stud 82, 92. The first end 51 of the elastic element is supported on the studs 82, 92. The head 81, 91 of each stop 8, 9 is arranged to cover a portion of the first end 51 of the elastic element 5 when the assembly is in the service position, thereby retaining said element in the z direction. With this variant, a rigid connection by isostatic obstacles is maintained, but in which three degrees of freedom of the elastic element relative to the first component are eliminated. With this variant, it is possible to secure assemblies which could be sensitive to impact, for example due to the mass of the components.

Alternatively, it is possible to provide a groove in the thickness of the first end of the elastic element, in which the heads 81, 91 of the stops 8, 9 are housed. With this variant, retention in the z direction is ensured without increasing the height of the assembly. In particular, it can be applied to the first form of execution above and to the connection between the counter-form 11 (which then has a groove around its perimeter) and the first end 21 of the return spring 2.

The embodiments and their variants described above are examples of implementation of the present invention. In particular, some of these embodiments and variants can be combined to form other variants, and these combinations and variants are within the reach of the person skilled in the art.

In general, the present invention relates to an assembly intended to equip a timepiece mechanism and comprising at least one elastic element and at least a first and a second timepiece components. The elastic element is intended to cooperate with each of the two timepiece components in order to set one of the components in motion relative to the other during operation of the assembly. The elastic element comprises a first end intended to cooperate with the first timepiece component and a second end intended to cooperate with the second timepiece component.

According to a first alternative of the invention, in the service position of the assembly in the timepiece mechanism, the elastic element is arranged to exert a prestressing torque on the first and second timepiece components, which torque tends to displace one of the timepiece components relative to the other (for example, return spring). In addition, the elastic element and its first end are shaped so that, in the operating position of the assembly, the said prestressing torque exerted by the elastic element on the first component and the second component holds the first end of the elastic element in abutment on the first component in at least three first point bearing zones arranged to eliminate at least two degrees of freedom of movement between the first end of the elastic element and the first component.

Preferably, the connection thus formed between the elastic element and the first component in the operating position of the assembly is isostatic.

Preferably, the elastic element, the second component and the second end of the elastic element are shaped so that, in the service position of the assembly, the torque exerted by the elastic element on the first component and the second component holds the second end of the elastic element in abutment on the second component at at least three second point bearing zones arranged to eliminate at least two degrees of freedom of movement between the second end and the second component.

Preferably, the connection thus formed between the elastic element and the second component in the operating position of the assembly is isostatic.

In a second alternative of the invention, the assembly further comprises elastic means distinct from the elastic element (in the sense that the elastic forces produced by one and the other are distinct and/or are not exerted on the same objects) and arranged to cooperate with the elastic element to maintain the first end of the elastic element in abutment on the first component at at least three first point bearing zones arranged to eliminate at least two degrees of freedom of movement between the first end of the elastic element and the first component.

In a variant of this second alternative, the elastic means are either attached to or integral with the elastic element.

In a general variant, the second end of the elastic element is rigidly fixed to the second component by means of two screws and a pin, by being crimped into a tenon, by means of a ball-and-socket joint or by being glued, soldered or joined in one piece to the said second end (traditional connections).

The first component and/or the second component are mobile or fixed components.

The first component is a mobile component and the second is a fixed component.

The present invention thus makes it possible to assemble an elastic element on a timepiece component that is suitable for all materials and in particular fragile materials such as silicon, oxidised silicon, glass, sapphire or ceramics, which ensures a rigid assembly between the elastic element and the timepiece component in the service position. The assembly according to the invention allows easy assembly, without tools, and also disassembly of the assembly, again without tools and without plastic deformation of parts. Depending on the variants, it is also possible to reduce the number of parts used (form/counter-form connections directly machined into the components), to reduce the overall dimensions or in any case not to increase them, to adjust the position and force of the elastic element and/or elastic means and to easily adapt existing components. In addition, the present invention proposes alternatives applicable to cases where the elastic element exerts sufficient torque on the timepiece component in the service position of the assembly and to cases where the elastic element does not (not at all or not always) exert sufficient torque on the timepiece component in the service position of the assembly. These alternatives apply the same principle of rigid connection by obstacles simply adapted to the arrangement of the elastic element in relation to the components with which it cooperates. The construction requirements for the elastic element or the additional elastic means according to the alternatives are not exaggerated since the torque exerted to maintain the connection by obstacles need not be excessive and the stressing can remain gentle.

1. Assembly intended to equip a timepiece mechanism and comprising at least one elastic element and at least one first and one second timepiece components the elastic element comprising a first end intended to cooperate with the first component and a second end intended to cooperate with the second component and the elastic element exerting, in the operating position of the assembly, a stress on the first and second timepiece componentswhich tends to displace one of the said timepiece components with respect to the other, wherein the first component, the elastic element and the first end are shaped so that, in the operating position of the assembly, the torque exerted by the elastic element on the first component and the second component keeps the first end of the elastic element in abutment on the first component at at least three first point bearing zones arranged to eliminate at least two degrees of freedom of movement between the first end of the elastic element and the first component.

2. The assembly according to claim 1, wherein the second component and the second end of the elastic element are shaped so that, in the service position of the assembly, the torque exerted by the elastic element on the first component and the second component maintains the second end of the elastic element in abutment on the second component at at least three distinct second bearing points arranged to eliminate at least two degrees of freedom of movement between the second end of the elastic element and the second component.

3. The assembly according to claim 2, charaterised wherein the assembly is arranged so that the connection thus formed between the elastic element and the second component in the service position is isostatic.

4. Assembly intended to equip a timepiece mechanism and comprising at least one elastic element and at least a first and a second timepiece component, the elastic element comprising a first end intended to cooperate with the first component and a second end intended to cooperate with the second component for the displacement of one of the components with respect to the other, the assembly further comprising elastic means arranged to cooperate with the elastic element to hold the first end of the elastic element in abutment on the first component in at least three first point contact zones arranged to eliminate at least two degrees of freedom of movement between the first end of the elastic element and the first component.

5. The assembly according to claim 1, wherein the assembly is arranged so that the connection thus formed between the elastic element and the first component in the service position is isostatic.

6. The assembly according to claim 1, wherein the second end of the elastic element is rigidly fixed to the second component by means of a screw/pin connection, by being crimped into a tenon, of a joint of the ball-and-socket type or by being glued, brazed or integrally joined to the said second end.

7. The assembly according to claim 1, wherein the first component and/or the second component are mobile or fixed components.

8. The assembly according to claim 1, wherein the first component is a mobile component and the second component is a fixed component.

9. The assembly according to claim 1, wherein one of the first component and the first end of the elastic element comprises two abutments while the other has a particular first shape such that in the service position of the assembly, the torque exerted by the elastic element on the first component and the second component or the torque exerted by the elastic means on the elastic element maintains the first shape in contact against the abutments, said contact being over said at least three point bearing areas.

10. The assembly according to claim 1, wherein the first component has a shape and the first end of the elastic element has a corresponding counter-shape so that, in the service position of the assembly, the torque exerted by the elastic element on the first component and the second component or the torque exerted by the elastic means on the elastic element maintains the shape in abutment in the counter-shape, the contact between the shape and the counter-shape taking place on the said at least three point bearing zones.

11. The assembly according to claim 1, wherein the first end of the elastic element and/or the first component are further arranged to eliminate a third degree of freedom of movement between the said elastic element and the first component in the service position.

12. The assembly as claimed in claim 11, wherein one of the first end of the elastic element or the first component comprises a groove in which a portion of the other of the elastic element or the first component is received.

13. The assembly as claimed in claim 11, wherein one of the one end of the elastic element or the first component comprises a shoulder arranged to overlie in the operative position a portion of the other of the elastic element or the first component.

14. The assembly according to claim 1, wherein the elastic element and/or the elastic means are made of metal, fragile materials or silicon, oxidised silicon, glass, sapphire or ceramic.

15. Timepiece comprising an assembly according to claim 1.

16. The assembly according to claim 3, wherein the assembly is arranged so that the connection thus formed between the elastic element and the first component in the service position is isostatic.

17. The assembly according to claim 16, wherein the second end of the elastic element is rigidly fixed to the second component by means of a screw/pin connection, by being crimped into a tenon, of a joint of the ball-and-socket type or by being glued, brazed or integrally joined to the said second end.

18. The assembly according to claim 17, wherein the first component and/or the second component are mobile or fixed components.

19. The assembly according to claim 18, wherein the first component is a mobile component and the second component is a fixed component.

20. The assembly according to claim 19, wherein one of the first component and the first end of the elastic element comprises two abutments while the other has a particular first shape such that in the service position of the assembly, the torque exerted by the elastic element on the first component and the second component or the torque exerted by the elastic means on the elastic element maintains the first shape in contact against the abutments, said contact being over said at least three point bearing areas.
